(19) United States
(12) Patent Application Publication
(10) Pub. No.: US 2019/0163374 A1
(43) Pub. Date: May 30, 2019

(54) STORING DATA OBJECTS USING DIFFERENT REDUNDANCY SCHEMES

(71) Applicant: ENTIT SOFTWARE LLC, Sanford, NC (US)

(72) Inventors: Lokesh Murthy Venkatesh, Karnataka (IN); Nandan Shantharaj, Karnataka (IN); Sunil Turakani, Karnataka (IN)

(21) Appl. No.: 16/179,615

(22) Filed: Nov. 2, 2018

(30) Foreign Application Priority Data
Nov. 28, 2017 (IN) 201741042718

(51) Int. Cl. G06F 3/06; G06F 11/14

(52) U.S. Cl. CPC G06F 3/065; G06F 11/1464; G06F 2201/805; G06F 3/0689; G06F 3/0604

(57) ABSTRACT

In some examples, as part of backing up a plurality of data objects to a target storage system, a system retrieves plural redundancy configuration information associated with respective data objects of the plurality of data objects, and stores backup data objects corresponding to the plurality of data objects in the target storage system using different redundancy schemes according to the retrieved plural redundancy configuration information.

### CROSS REFERENCE TO RELATED APPLICATION

This application claims the benefit of Indian Application No. 201741042718 filed 28 Nov. 2017, which is hereby incorporated by reference.

### BACKGROUND

A storage system can include a storage device or multiple storage devices to store data. In some cases, data in a primary storage system can be replicated to a backup storage system. The replicated data stored in the backup storage system can be used to recover from any failure or fault of the primary storage system or loss of data at the primary storage system.

### BRIEF DESCRIPTION OF THE DRAWINGS

Some implementations of the present disclosure are described with respect to the following figures.

FIG. 1 is a block diagram of an arrangement that includes a primary storage system in a backup storage system, according to some examples.

FIG. 2 is a flow diagram of a process of backing up data according to some examples.

FIG. 3 is a flow diagram of a process of restoring data according to further examples.

FIG. 4 is a block diagram of a system according to some examples.

FIG. 5 is a block diagram of a storage medium storing machine-readable instructions according to further examples.

FIG. 6 is a flow diagram of a process according to additional examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A backup product can be used to support backup of data to target storage systems, which can include disk-based storage systems, tape-based storage systems, and so forth. As used here, a “product” can refer to machine-readable instructions (such as in the form of a program or multiple programs) or a combination of machine-readable instructions and processing hardware in which the machine-readable instructions are executable. A processing hardware can include any or some combination of the following: a microprocessor, a core of a multi-core microprocessor, a microcontroller, a programmable integrated circuit, a programmable gate array, or another hardware processing circuit

A “target storage system” can include a single storage device or a collection of multiple storage devices to store backup data. A storage device can include any of the following: a disk-based storage device, a tape-based storage device, a solid state memory device, and so forth. Management of data stored in the target storage system can be performed by a target storage client (discussed further below).

In case of loss of data at a primary storage system, the backup data can be restored from a target storage system. A “primary storage system” can include a single storage device or multiple storage devices that stores a primary version of the data that is used during normal operation (i.e., operation where the primary storage system is not experiencing a failure of fault that prevents the access or storage of data, or operation where data loss is not being experienced at the primary storage system). Management of data stored in the primary storage system can be performed by a primary storage client (discussed further below). Normally, if the primary version of the data is available, the primary storage system (or a device that has access to the primary storage system) uses the primary version of the data.

The backup data is accessed from the target storage system in response to loss or corruption of the primary version of the data, such as due to a failure or fault of device(s) at the primary storage system.

If the backup data stored to a target storage system is not protected by a redundancy scheme, then any corruption of the backup data can prevent successful recovery of the data from the target storage system. In such a scenario, both the primary version of the data and the backup data may be corrupted, which can lead to unrecoverable data loss.

In accordance with some implementations of the present disclosure, redundancy schemes can be used to protect backup data stored in a target storage system. It is noted that storing data to a target storage system can refer to storing data to a single target storage system or to multiple target storage systems. Similarly, restoring data from a target storage system can refer to restoring data from a single target storage system or from multiple target storage systems.

A “redundancy scheme” can refer to a scheme for storing data where redundant information is used to protect the integrity of the data. In some examples, redundant information for a particular data object can include a mirror copy (duplicate copy) of the data object. In other examples, redundant information for a particular data object can include parity information for the particular data object. The parity information can be used to check for corruption of the particular data object, and for certain corruption, the parity information can be used to rebuild the particular data object. More generally, “redundant information” can refer to information that can be used to rebuild data in case of loss of the data (or a portion of the data).

A “data object” can refer to any unit of data that is separately identifiable when stored in a storage system. For example, a data object can include a file of a file system. In other examples, a data object can include any other piece of information.

In accordance with some implementations of the present disclosure, respective redundancy configuration information can be associated with respective data objects. Each redundancy configuration information can specify the redundancy scheme to be used for a respective data object (or a respective set of data objects). As a result, different data objects can be stored in a target storage system using different redundancy schemes according to the respective redundancy configuration information.

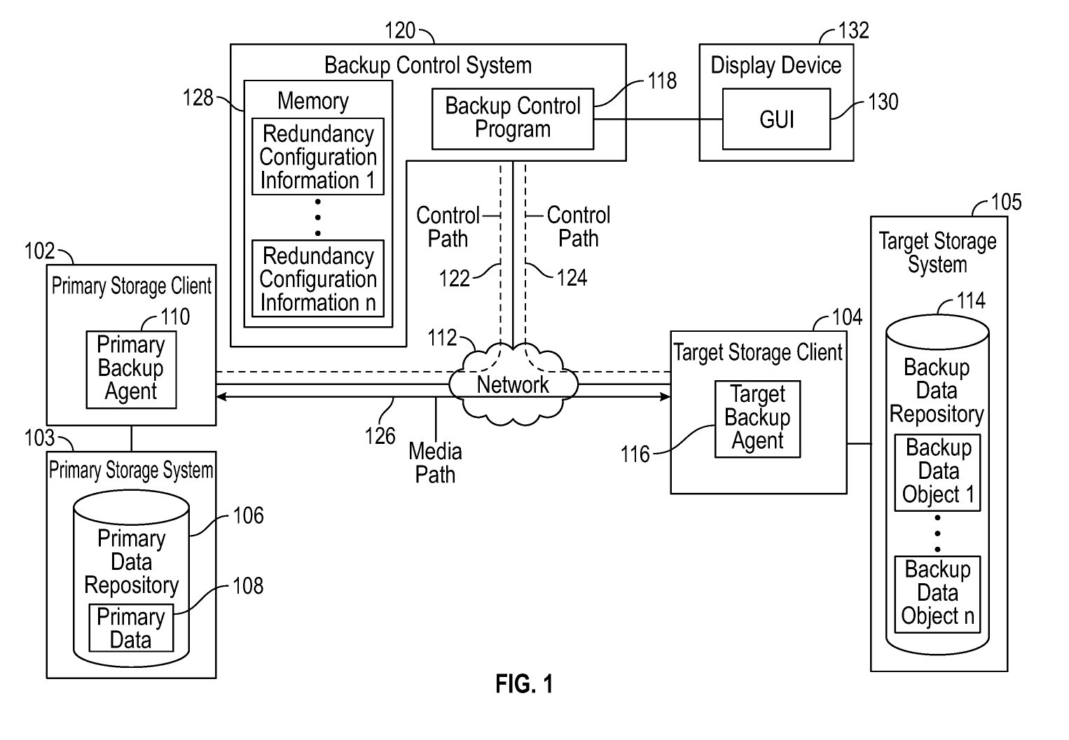

FIG. 1 is a block diagram of an example arrangement that includes a primary storage client 102, a primary storage system 103, a target storage client 104, and a target storage system 105. The primary storage client 103 can be implemented as a computer, or a collection of computers. Similarly, the target storage client 105 can be implemented as a computer, or a collection of computers. The primary storage system 103 can be separate from but communicatively connected to the primary storage client 102, or alternatively, can be part of the primary storage client 102. Similarly, the target storage system 105 can be separate from but communicatively connected to the target storage client 104, or alternatively, can be part of the target storage client 104.

Although FIG. 1 depicts just one primary storage client 102 and one primary storage system 103 and one target storage client 104 and one target storage system 105, it is noted that techniques or mechanisms discussed herein can also be applied to multiple primary storage clients and systems and/or multiple target storage clients and systems.

The primary storage system 103 includes a primary data repository 106 that contains primary data 108. The primary storage system 103 can be implemented using a storage device or multiple storage devices (such as an array of storage devices).

The primary storage client 102 includes a backup agent 110 (referred to as a “primary backup agent”) that can manage the transfer of data from the primary storage system 103 over a network 112 to the target storage client 104 to store backup data in a backup data repository 114 in the target storage system 105. The target storage system 105 can be implemented using a storage device or multiple storage devices (such as an array of storage devices).

The target storage client 104 includes a backup agent 116 (referred to as a “target backup agent”), which can cooperate with the primary backup agent 110 of the primary storage client 102 to transfer data from the primary storage system 103 to the target storage system 105 to perform backup of data.

Additionally, the backup agents 110 and 116 can cooperate to restore data from the backup data repository 114, in case of data loss at the primary data repository 106. The restored data can be transferred by the target backup agent 116 to the primary storage client 102.

As used here, a “backup agent” can refer to machine-readable instructions (in the form of a program or multiple programs) that can execute in the respective storage client. Alternatively, a “backup agent” can refer to a combination of machine-readable instructions and processing hardware in which the machine-readable instructions are executable.

In some examples, the backup agents 110 and 116 can be controlled by a backup control program 118 (including machine-readable instructions) that is executable in a backup control system 120. The backup control system 120 can be implemented as a computer or as a distributed arrangement of computers. Although the backup control program 118 is shown as being executable in the backup control system 120 that is separate from the primary storage client 102 and the target storage client 104 in examples according to FIG. 1, it is noted that in other examples, the backup control program 118 can be part of the primary storage client 102 and/or part of the target storage client 104.

As depicted in FIG. 1, the backup control program 118 can exchange control messages with the backup agents 110 and 116 over respective control paths 122 and 124 through the network 112. The control messages provided by the backup control program 118 to the backup agents 110 and 116 can perform various control actions, including any or some combination of the following: scheduling backup of data from the primary storage system 103 to the target storage system 105, such as at periodic intervals or in response to events; identifying data objects of the primary data 108 to backup to the target storage system 105; setting a full backup or an incremental backup (where an incremental backup refers to a backup of data that has changed since a previous backup, and a full backup refers to a complete backup of the primary data 108 in the primary data repository 106); load balancing usage of storage devices in the target storage system 105; controlling restoring of backup data from the target storage system 105; storing redundancy configuration information associated with the data objects as set by a user or another entity, and so forth.

The backup agents 110 and 116 can communicate data over a media path 126 through the network 112, for the purpose of backing up data from the primary data repository 106 to the backup data repository 114, or to transfer restored data from the backup data repository 114 to the primary data repository 106.

As shown in FIG. 1, the primary data 108 can be backed up to the backup data repository 114 as backup data object 1 to backup data object n, where n>1. In some examples, a backup data object can include a file (or a collection of files). In other examples, a backup data object can include any other piece of information (or combination of pieces of information).

In accordance with some implementations of the present disclosure, each backup data object can be stored in the data backup repository 114 using a respective redundancy scheme specified by a redundancy configuration information for the backup data object. In the example of FIG. 1, the backup control system 120 includes a memory 128 that stores redundancy configuration information 1 to redundancy configuration information n. The target backup agent 116 retrieves the redundancy configuration information from the backup control program 118 for each respective backup data object. The retrieved redundancy configuration information can be stored in a memory of the target storage client 104 for further use in backup and/or restore operations.

Redundancy configuration information 1 specifies the redundancy scheme to use for backup data object 1, and redundancy configuration information n specifies the redundancy scheme to use for backup data object n. Redundancy configuration information 1 and redundancy configuration information n can specify different redundancy schemes to use for the backup data objects 1 and n, respectively.

More generally, redundancy configuration information i (where i=1 to n) specifies the redundancy scheme to use for the corresponding backup data object i. In some examples, the redundancy configuration information i can include a parameter that can be set to any of different values, where the different values identify corresponding different redundancy schemes to use.

Although FIG. 1 shows that the redundancy configuration information 1 to n are stored in the memory 128 of the backup control system 120, it is noted that in other examples, the redundancy configuration information can be stored elsewhere in another system.

Additionally, although FIG. 1 shows a one-to-one correspondence between each redundancy configuration information and a corresponding backup data object, it is noted that in further examples, a respective redundancy configuration information can control the redundancy scheme to use for multiple backup data objects in the backup data repository 114. In such further examples, redundancy configuration information i can specify the redundancy scheme to use for a corresponding collection of backup data objects.

By being able to individually specify redundancy schemes for each backup data object (or each collection of backup data objects), more flexibility is provided to allow for more efficient and effective protection of data objects in the backup data repository 114. Different redundancy schemes can have different complexities, with certain redundancy schemes being more complex or costly (in terms of the amount of storage space used) than other redundancy schemes. By being able to specify different redundancy schemes for different backup data objects in the backup data repository 114, certain data objects can be protected using a higher level of redundancy than other data objects (e.g., higher priority data can be associated with a redundancy scheme that affords a greater level of protection than lower priority data objects). The priority of a data object can be specified by administrators or other users, or by programs or machines.

In some examples, the different redundancy schemes specified by respective redundancy configuration information can include different Redundant Array of Independent Disks (RAID) levels, such as the levels shown in Table 1 below.

TABLE 1

| RAID LEVEL | Description |
|---|---|
| RAID-1 | Data Mirroring, without parity or striping |
| RAID-2 | Bit-level striping with dedicated Hamming-code parity |
| RAID-3 | Byte-level striping with dedicated parity |
| RAID-4 | Block-level striping with dedicated parity |
| RAID-5 | Block-level striping with distributed parity |
| RAID-6 | Block-level striping with double distributed parity |

The different RAID levels include RAID-1, RAID-2, RAID-3, RAID-4, RAID-5, and RAID-6. With RAID-1, a primary data object of the primary data 108 is simply replicated as a corresponding backup data object in the backup data repository 114 (i.e., the entirety of the primary data object is copied as a mirror copy in the backup data repository 114). With any of RAID-2 through RAID-6, parity information is computed and stored in the corresponding backup data object. Parity information is computed based on actual data of a corresponding data object, such as by computing an exclusive-OR (XOR) of data bits or bytes of a data object. Moreover, with RAID-2 to RAID-6, striping of data can be performed, in which each data object can be broken into different portions and stored across (striped) multiple storage devices of the backup data repository 114.

In examples of FIG. 1, the backup control program 118 can present a graphical user interface (GUI) 130 for display in a display device 132. Alternatively, the backup control program 118 can present a command line interface (CLI) or any other interface in the display device 132. The examples discussed herein refers to the GUI 130 for ease of readability. The display device 132 can be part of the backup control system 120, or can be part of a device that is remote from the backup control system 120. Using the GUI 130, a user can control backup and restore operations of the primary and target storage systems 102 and 104.

Moreover, in some examples, the GUI 130 can be used to set the redundancy configuration information for each respective data object to be backed up to the target storage system. A user can provide user input in the GUI 130 to set the redundancy configuration information. The setting of the redundancy configuration information is received by the backup control program 118 (either from the GUI 130 or from another source such as a program or a machine) as part of a backup configuration for data objects to be backed up to the target storage system 104.

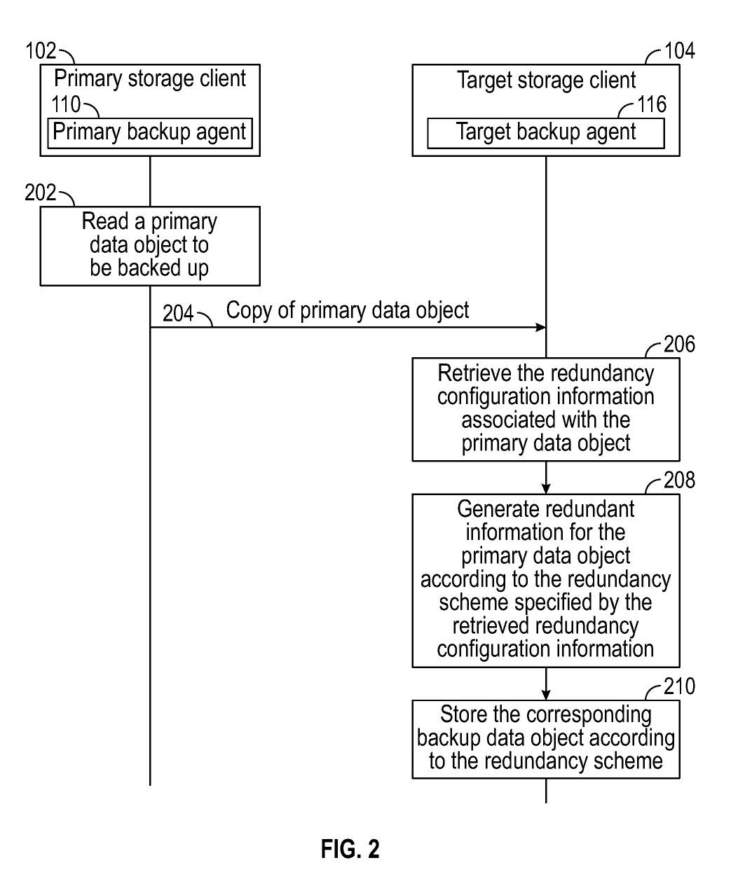

FIG. 2 is a flow diagram of a process of performing backup of data from the primary storage client 102 to the target storage client 104, according to some examples. The primary backup agent 110 of the primary storage client 102 reads (at 202) a primary data object to be backed up from the primary data repository 106. The reading of the primary data object to be backed up can be performed at a scheduled time for performing a backup, or in response to a command from the backup control program 118. The primary backup agent 110 sends (at 204) a copy of the primary data object to the target storage system 104 over the media path 126 through the network 112.

In response to receiving the copy of the primary data object, the target backup agent 116 of the target storage system 104 retrieves (at 206) the redundancy configuration information associated with the received primary data object. The redundancy configuration information can be retrieved from the memory 128 of the backup control system 120 or from another storage location.

The target backup agent 116 then generates (at 208) redundant information for the primary data object according to the redundancy scheme specified by the retrieved redundancy configuration information. If the redundancy scheme is one that uses parity information, then the redundant information that is generated (at 208) includes parity information that is computed based on portions of data of the primary data object. Alternatively, if the redundancy scheme is a mirroring scheme, such as according to RAID-1, then the redundant information that is generated is simply a mirror copy of the primary data object.

The target backup agent 116 stores (at 210) the corresponding backup data object in the backup data repository 114 according to the specified redundancy scheme. If the redundancy scheme (e.g., RAID-1) uses mirroring of the primary data object, then the backup data object that is stored is simply a mirror copy of the primary data object. On the other hand, if the redundancy scheme uses parity information, then the backup data object stored includes the data of the primary data object as well as the corresponding parity information. Additionally, the backup data object is striped across the storage devices of the backup data repository 114 according to the striping used by RAID-2 to RAID-6.

The following describes an example of storing a backup data object where the redundancy scheme used is RAID-3, which involves use of byte-level striping with dedicated parity. In this example, a primary data object can be split into three bytes B1, B2, and B3. In addition, a parity byte (PB) can be computed based on B1, B2, and B3, as follows: PB=B1 XOR B2 XOR B3.

Once the parity byte PB is calculated, the four bytes (B1, B2, B3, PB) that make up the backup data object is striped across four storage devices of the backup data repository 114.

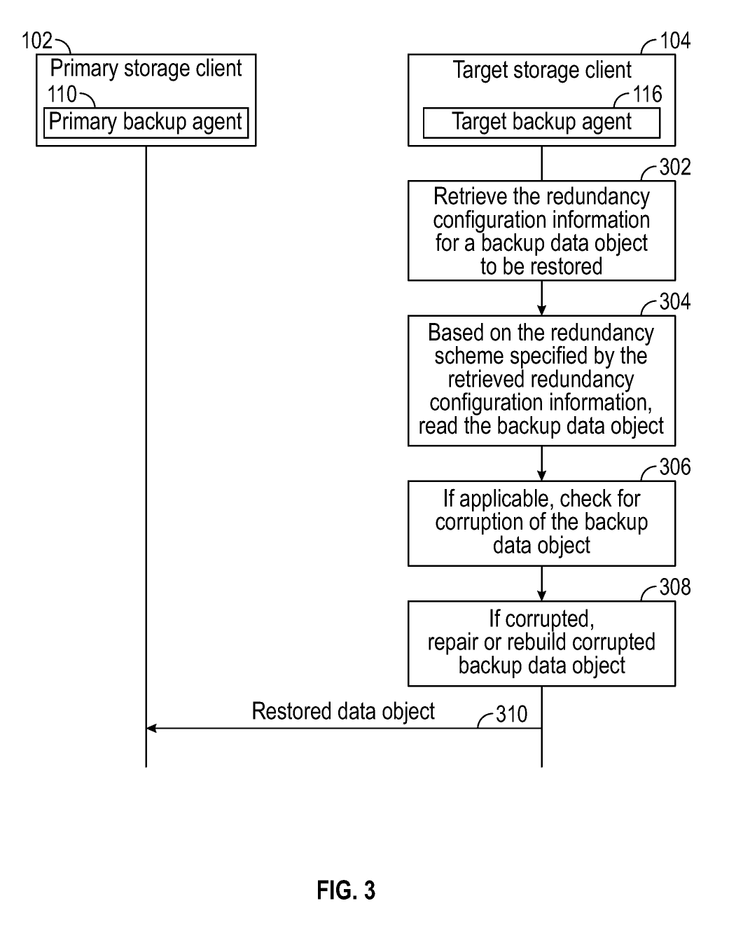

FIG. 3 is a message flow diagram of a restore process to restore a backup data object (or multiple backup data objects) from the backup data repository 114. The restore process may be initiated in response to a command from the backup control program 118, for example. The restore process can be triggered if there is detected data loss at the primary storage system 103.

The target backup agent 116 of the target storage client 104 retrieves (at 302) the redundancy configuration information for a backup data object to be restored. This redundancy configuration information specifies the redundancy scheme used at the time that the backup data object was stored in the backup data repository 114.

Based on the redundancy scheme specified by the retrieved redundancy configuration information, the target backup agent 116 reads (at 304) the backup data object. If striping is used, then multiple portions of the backup data object can be read from corresponding storage devices of the backup data repository 114.

If applicable, the target backup agent 116 checks (at 306) for corruption of the backup data object. For example, checking for corruption can be used if any of RAID-2 to RAID-6 is used. The parity information for any of the foregoing RAID levels can be used to determine whether or not a byte or bit of the backup data object is corrupted, and if so, to repair or rebuild (at 308) the data using the retrieved portions of the backup data object and the parity information. In case of RAID-1, a warning can be displayed to the user to indicate the corruption in the backup data repository 114.

The following provides an example restore process where RAID-3 is used. The backup data object that is retrieved includes bytes B1, B2, and B3 along with parity byte PB. To check for corruption of the backup data object, the target backup agent 116 re-generates a parity byte, PB′, based on the retrieved bytes B1, B2, and B3, as follows: PB′=B1 XOR B2 XOR B3.

If the re-generated parity byte, PB′ is not the same as the parity byte PB that is part of the backup data object retrieved from the backup data repository 114, then that indicates that corruption of the backup data object has occurred. In this scenario, the target backup agent 116 can determine which of B1, B2, and B3 is corrupted. To determine if B1 is corrupted, the target backup agent 116 re-generates B1′ as follows: B1′=PB XOR B2 XOR B3. From a parity byte, PB″, is re-calculated as follows: PB″=B1′ XOR B2 XOR B3. If PB″ is not equal to PB, then that indicates that byte B1 is not corrupted.

The process can then proceed to use a similar procedure to determine if either byte B2 or B3 is corrupted. If the re-calculated parity byte PB″ is equal to PB, then that indicates that byte B1 is corrupted. Since it is determined that byte B1 is corrupted, an exclusive-OR can be performed of B2, B3, and PB to rebuild B1, as follows: B1=PB XOR B2 XOR B3.

In other examples, if any of B1, B2, or B3 cannot be read, then the parity byte PB can be used with the other readable bytes to rebuild the byte that is not readable.

The backup data object that is read from the backup data repository 114 (after any rebuilding if applicable) is sent (at 310) by the target backup agent 116 to the primary storage client 102 as a restored data object, which can replace the lost or corrupted primary data object in the primary data repository 106.

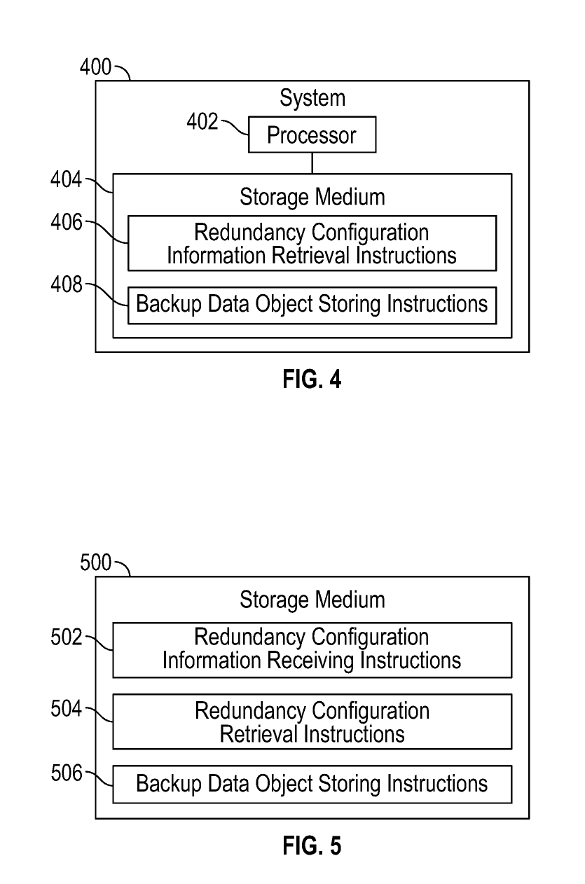

FIG. 4 depicts a system 400 including a processor 402 and a non-transitory storage medium 404 storing instructions executable on the processor 402 to perform various tasks. Instructions executable on a processor can refer to instructions executable on a single processor or instructions executable on multiple processors. A processor can include a microprocessor, a core of a multi-core microprocessor, a microcontroller, a programmable integrated circuit, a programmable gate array, or another hardware processing circuit.

The instructions stored in the storage medium 404 include instructions to perform tasks as part of backing up a plurality of data objects to a target storage system. The instructions include redundancy configuration information retrieval instructions 406 to retrieve plural redundancy configuration information associated with respective data objects of the plurality of data objects, and backup data object storing instructions 408 to store backup data objects corresponding to the plurality of data objects in the target storage system using different redundancy schemes according to the retrieved plural redundancy configuration information.

FIG. 5 is a block diagram of a non-transitory machine-readable or computer-readable storage medium 500 storing instructions that upon execution cause a system to perform various tasks. The instructions include redundancy configuration information receiving instructions 502 to, as part of configuring backup storage for a plurality of data objects to a target storage system, receive plural redundancy configuration information for respective data objects of the plurality of data objects. For example, the plural redundancy configuration information can be received from the GUI 130 shown in FIG. 1. The instructions further include instructions 504 and 506 to perform tasks as part of backing up the plurality of data objects to the target storage system. The instructions 504 are redundancy configuration retrieval instructions to retrieve the plural redundancy configuration information associated with the respective data objects, and the instructions 506 are backup data object storing instructions to store backup data objects corresponding to the plurality of data objects in the target storage system using different redundancy schemes according to the retrieved plural redundancy configuration information.

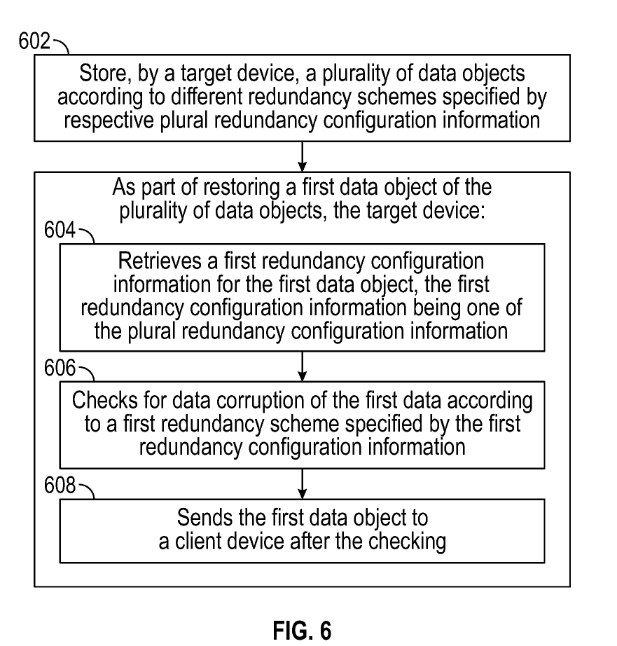

FIG. 6 is a flow diagram of a process according to additional examples. The process includes storing (at 602), by a target device (e.g., the target storage client 104), a plurality of data objects according to different redundancy schemes specified by respective plural redundancy configuration information. As part of restoring a first data object of the plurality of data objects, the target device retrieves (at 604) a first redundancy configuration information for the first data object, the first redundancy configuration information being one of the plural redundancy configuration information, checks (at 606) for data corruption of the first data object according to a first redundancy scheme specified by the first redundancy configuration information, and sends (at 608) the first data object to a client device after the checking and if applicable based on redundancy scheme, repair or rebuild the data.

The storage medium 404 (FIG. 4) or 500 (FIG. 5) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A system comprising:
a processor; and
a non-transitory storage medium storing instructions executable on the processor to:
as part of backing up a plurality of data objects to a target storage system:
retrieve plural redundancy configuration information associated with respective data objects of the plurality of data objects; and
store backup data objects corresponding to the plurality of data objects in the target storage system using different redundancy schemes according to the retrieved plural redundancy configuration information.

2. The system of claim 1, wherein the different redundancy schemes comprise different Redundant Array of Independent Disks (RAID) levels.

3. The system of claim 1, wherein a first redundancy configuration information of the plural redundancy configuration information includes a parameter specifying use of a first redundancy scheme, and a second redundancy configuration information of the plural redundancy configuration information includes a parameter specifying use of a second redundancy scheme, and
wherein the storing of the backup data objects in the target storage system using the different redundancy schemes is according to the plural redundancy configuration information including the first and second redundancy configuration information.

4. The system of claim 1, wherein the instructions are executable on the processor to further:
receive the plural redundancy configuration information as part of a backup configuration for the plurality of data objects.

5. The system of claim 4, wherein the instructions are executable on the processor to further:
present a user interface relating to the backup configuration,
wherein the receiving of the plural redundancy configuration information is responsive to user input in the user interface.

6. The system of claim 1, wherein the instructions are executable on the processor to further:
as part of restoring a first data object from the target storage system:
retrieve a first redundancy configuration information for the first data object; and
check for data corruption of the first data object according to a first redundancy scheme specified by the first redundancy configuration information.

7. The system of claim 6, wherein the instructions are executable on the processor to further:
as part of restoring the first data object from the target storage system, rebuild the first data object according to the first redundancy scheme in response to detecting the data corruption.

8. The system of claim 7, wherein the instructions are executable on the processor to further:
as part of restoring the first data object from the target storage system, compute redundancy information according to the first redundancy scheme,
wherein the rebuilding of the first data object uses the computed redundancy information.

9. The system of claim 8, wherein the computed redundancy information used to rebuild the first data object comprises parity information of a Redundant Array of Independent Disks (RAID) level.

10. The system of claim 1, wherein the instructions are executable on the processor to further:
as part of backing up the plurality of data objects to the target storage system:
generate different redundancy information according to the different redundancy schemes for the respective data objects of the plurality of data objects; and
store the generated different redundancy information as part of the respective backup data objects in the target storage system.

11. A non-transitory machine-readable storage medium storing instructions that upon execution cause a system to:
as part of configuring backup storage for a plurality of data objects to a target storage system, receive plural redundancy configuration information for respective data objects of the plurality of data objects; and
as part of backing up the plurality of data objects to the target storage system:
retrieve the plural redundancy configuration information associated with the respective data objects; and
store data objects corresponding to the plurality of data objects in the target storage system using different redundancy schemes according to the retrieved plural redundancy configuration information.

12. The non-transitory machine-readable storage medium of claim 11, wherein the instructions upon execution cause the system to:
as part of backing up the plurality of data objects to the target storage system:
generate different redundancy information according to the different redundancy schemes for the respective data objects of the plurality of data objects; and
store the generated different redundancy information as part of the respective backup data objects in the target storage system.

13. The non-transitory machine-readable storage medium of claim 12, wherein the different redundancy schemes comprise different Redundant Array of Independent Disks (RAID) levels.

14. A method comprising:
storing, by a target device, a plurality of data objects according to different redundancy schemes specified by respective plural redundancy configuration information; and
as part of restoring a first data object of the plurality of data objects, the target device:
retrieving a first redundancy configuration information for the first data object, the first redundancy configuration information being one of the plural redundancy configuration information;
checking for data corruption of the first data object according to a first redundancy scheme specified by the first redundancy configuration information; and
sending the first data object to a client device after the checking.

15. The method of claim 14, further comprising:
rebuilding the first data object using redundancy information for the first redundancy scheme in response to detecting the data corruption of the first data object,
wherein the sending of the first data object to the client device comprises sending the rebuilt first data object.
